(19) United States
(12) Patent Application Publication
(10) Pub. No.: US 2008/0169406 A1
(43) Pub. Date: Jul. 17, 2008

(54) Pole assembly with anchor cover

(75) Inventors: Matthew John Weiss, Highland Village, TX (US); Michael Eugene Olsen, Frisco, TX (US)

Correspondence Address: MUNSCH, HARDT, KOPF & HARR, P.C.;INTELLECTUAL PROPERTY DOCKET CLERK, 3800 LINCOLN PLAZA, 500N AKARD STREET, DALLAS, TX, 75201, US

(73) Assignee: Craftmade International Inc.

(21) Appl. No.: 12/008,330

(22) Filed: Jan. 10, 2008

Related U.S. Application Data
(60) Provisional application No. 60/880,296, filed on Jan. 12, 2007.

(51) Int. Cl. F16M 13/02

(52) U.S. Cl. 248/519

(57) ABSTRACT

A pole assembly comprises a pole configured to have a fixture coupled to one end thereof, the pole coupleable to an anchor to support the pole, and a cover having a shape geometrically complementary to a shape of the anchor to at least partially conceal at least a portion of the anchor.

### RELATED APPLICATIONS

The present patent application claims priority to U.S. Provisional Patent Application No. 60/880,296 entitled “POLE ASSEMBLY WITH ANCHOR SYSTEM COVER”, filed on Jan. 12, 2007.

### BACKGROUND

There are a variety of types of indoor/outdoor furniture and/or accessories that are configured to be mounted onto a pole or other type of vertical rod-type structure such as weather gauges, clocks, fans, light fixtures, etc. However, because these devices generally sit atop the pole, the assembly may become imbalanced. Further, weights or structure that bolts the pole assembly to a support structure oftentimes detracts from the appearance of the assembly.

### BRIEF DESCRIPTION OF THE DRAWINGS

FIG. 1 is a diagram illustrating a pole assembly in which an embodiment of an anchor cover is employed to advantage;

FIG. 2 is a diagram illustrating an exploded assembly view of a portion of the pole assembly of FIG. 1;

FIG. 3 is a diagram illustrating a section view of a portion of the pole assembly of FIG. 1 taken along the line 3-3 of FIG. 1; and

FIG. 4 is a diagram illustrating a pole assembly in which an embodiment of an anchor cover is employed to advantage.

### DETAILED DESCRIPTION OF THE DRAWINGS

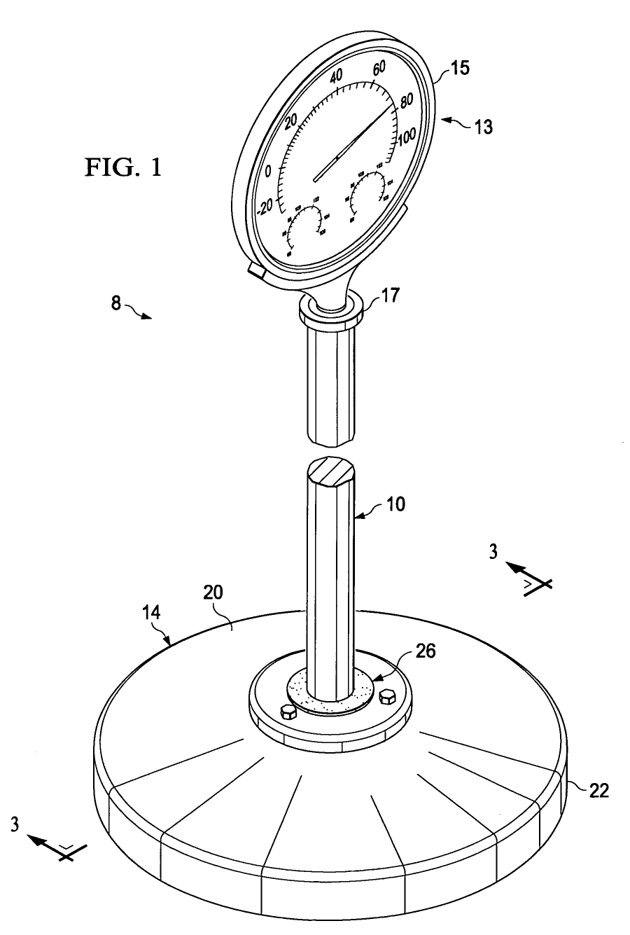

The preferred embodiments and the advantages thereof are best understood by referring to FIGS. 1-4 of the drawings, like numerals being used for like and corresponding parts of the various drawings.

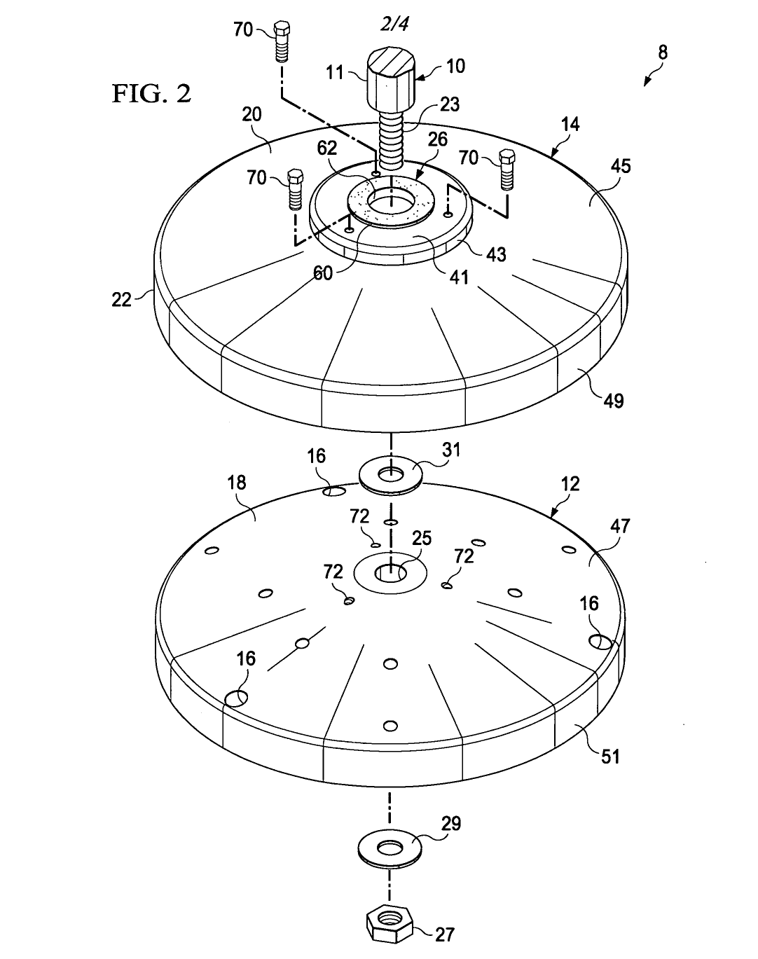

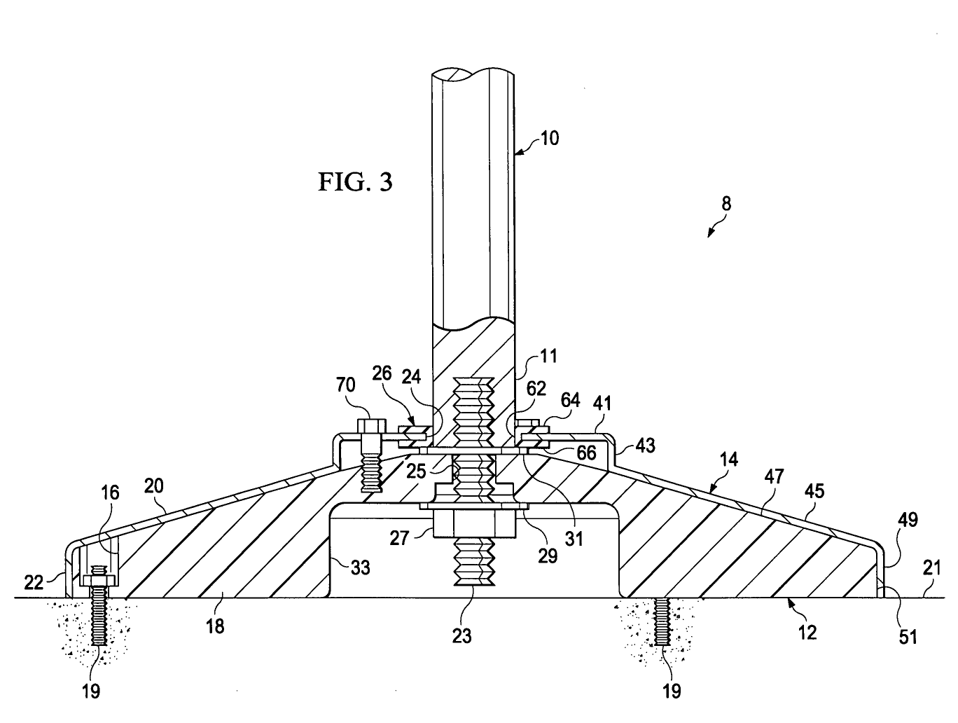

FIG. 1 is a diagram illustrating a pole assembly 8 in which an embodiment of an anchor cover 14 is employed to advantage, FIG. 2 is a diagram illustrating an exploded assembly view of a portion of pole assembly 8 of FIG. 1, and FIG. 3 is a diagram illustrating a section view of a portion of pole assembly 8 of FIG. 1 taken along the line 3-3 of FIG. 1. Referring to FIGS. 1-3, pole assembly 8 comprises a pole 10 having an end 11 coupled to an anchor 12. Pole 10 is configured to support a variety of indoor and/or outdoor fixtures 13 such as, but not limited to light fixtures, temperature gauges, pressure gauges, clocks, signs, fans, etc. Pole 10 may be formed having any geometric configuration (e.g., circular, hexagonal, octagonal, etc.). In the embodiment illustrated in FIG. 1, fixture 13 comprises a temperature/barometric pressure gauge 15 coupled to an end 17 of pole 10. Fixture 13 may be mounted to end 17 of pole 10 using a variety of different types of methods and/or devices such as, but not limited to, bolts, clips, adhesives/epoxies, and snap-fit elements.

Pole 10 is coupled to anchor 12 to enable pole 10 to be supported in a generally upright or otherwise desired position. In the embodiment illustrated in FIGS. 1-3, anchor 12 comprises one or more openings 16 to enable attachment and/or anchoring of anchor 12 via one or more bolts 19 or another type of attachment mechanism to a support surface 21 such as, for example, porches, patios, sidewalks or any other structures in which pole 10 may be disposed thereon. It should be understood that anchor 12 may comprise, in addition to or in lieu of openings 16, a weighted housing 18 to anchor and/or otherwise support pole 10 on support surface 21 in the generally upright position.

In the embodiment illustrated in FIGS. 1-3, end 11 of pole 10 comprises a threaded element 23 that is insertable through a centrally located opening 25 in anchor 12. Referring to FIGS. 2 and 3, in the illustrated embodiment, end 11 of pole 10 is secured to anchor 12 using a nut 27 threadably engageable with threaded element 23 and washers 29 and 31. However, it should be understood that end 11 of pole 10 may be secured to anchor 12 using other types of methods and/or mechanisms. Referring to FIG. 3, in the illustrated embodiment, a side of anchor 12 facing support surface 21 comprises a recessed area 33 to enable access to end 11 of pole 10 from a side of anchor 12 to be positioned against support surface 21 and providing a cavity for housing mechanisms used to secure pole 10 to anchor 12 while also enabling anchor 12 to be seated flush against support surface 21.

In the embodiment illustrated in FIGS. 1-3, cover 14 is shaped to conform and/or is otherwise geometrically complementary to at least a portion of anchor 12 such that when disposed over anchor 12, cover 14 fits snug over anchor 12. For example, in the embodiment illustrated in FIGS. 1-3, a majority of cover 14 is shaped to conform and/or is otherwise geometrically complementary to anchor 12. In the illustrated embodiment, cover 14 comprises a top surface 20 and a skirt 22 extending downward from a periphery of top surface 20 for enclosing and/or covering anchor 12. In the embodiment illustrated in FIGS. 1-3, cover 14 overlays and otherwise covers the entire portion of anchor 12; however, it should be understood that cover 14 may cover only a portion of anchor 12.

In the embodiment illustrated in FIGS. 1-3, cover 14 comprises a centrally located annular opening 24 extending through a generally planar and horizontal support flange 41. Support flange 41 extends concentrically outward from opening 24 and transitions to a generally vertical flange 43 which extends downwardly toward anchor 12. However, it should be understood that the angular relationship of flange 43 relative to flange 41 may be otherwise configured. As best illustrated in FIGS. 2 and 3, flange 43 is formed generally concentric with opening 24 and transitions to a downwardly tapered flange 45 that is shaped to conform and/or is otherwise geometrically complementary to an upwardly-facing surface 47 of anchor 12. Flange 45 transitions to a flange 49 extending vertically downward and located generally concentric with opening 12 and is located to fir snugly against an outer surface 51 of anchor 12. Thus, in the illustrated embodiment, cover 14 overlays and otherwise conceals openings 16 to provide a smooth and aesthetically appealing surface for anchor 12.

In the embodiment illustrated in FIGS. 1-3, pole 10 is insertable through opening 24 disposed in cover 14. In some embodiments, cover 14 comprises a sealing member 26 extending around a periphery of opening 24 and extending inwardly toward pole 10 to sealingly engage about a perimeter of pole 10 to reduce or eliminate water, dirt or any other unwanted debris from entering between pole 10 and cover 14. Further, sealing member 26 is configured to prevent cover 14 from scratching or otherwise damaging pole 10 as cover 14 is inserted over pole 10 and positioned over anchor 12. In some embodiments, sealing member 26 comprises a generally flexible gasket 60 having an annular opening 62 with two outwardly extending and spaced apart walls 64 and 66 for receiving a portion of flange 41 therebetween. In some embodiments, sealing member 26 is formed from an elastomeric material such that sealing member 26 is to some degree flexible to enable pole 10 to slide through opening 62 while enabling sealing member 26 to fit snugly around pole 10. However, it should be understood that sealing member 26 may be formed of other materials. Sealing member 26 and, specifically, opening 62 is configured to complement a geometric shape of pole 10 (e.g., circular, hexagonal, octagonal, etc.).

To assemble and/or install pole assembly 8, bolts 19 are inserted through openings 16 for attachment and anchoring of anchor 12 to support surface 21. However, as described above, in some embodiments, bolts 19 may be omitted (e.g., the weight of anchor 12 itself may be sufficient to maintain pole assembly 8 in an upright position). Pole 10 may be coupled to anchor 12 before attachment of anchor 12 to support surface 21 or thereafter (e.g., in some embodiments, pole 10 may be configured to be threaded directly into anchor 12 such that access to a side of anchor 12 placed against support surface 21 is unnecessary). Cover 14 is aligned with pole 10 such that pole 10 is inserted through opening 24. Cover 14 is slideable down the length of pole 10 until cover 14 overlays and otherwise encloses and conceals anchor 12 and, specifically, openings 16. Fixture 13 is coupled to end 17 of pole 10.

In some embodiments, cover 14 is coupled to anchor 12 via a plurality of bolts 70 threadably insertable into corresponding openings 72 in anchor 12. However, it should be understood that cover 14 may be otherwise coupled to anchor 12 (e.g., frictional engagement with anchor 12, coupled together via an adhesive, or cover 14 may simply rest over anchor 12 without a positive retention mechanism).

Thus, in operation, cover 14, and sealing member 26, are configured to abut and/or otherwise engage/contact at least a portion of pole 10 (e.g., near end 11). Embodiments of pole assembly 8 provide a cover 14 to at least partially conceal and enclose anchor 12 to enable concealment of openings 16 and the associated attachment bolts. Furthermore, embodiments or pole assembly 8 provide a cover 14 that is shaped substantially corresponding to the shape of anchor 12 and is geometrically complementary in shape to anchor 12 so as to fit snug over anchor 12. In addition, embodiments of pole assembly 8 provide a cover 14 comprising a sealing member 26 to prevent unwanted debris from entering between cover 14 and pole 10.

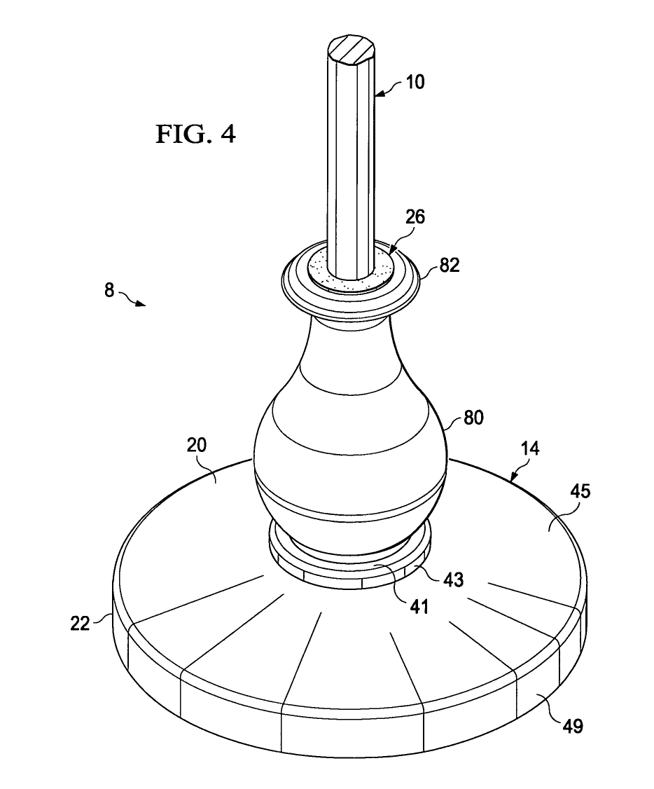

FIG. 4 is a diagram illustrating another embodiment of pole assembly 8. In the embodiment illustrated in FIG. 4, cover 14 extends upwardly to also cover at least a portion of pole 10. For example, in the embodiment illustrated in FIG. 4, cover 14 comprises a bulbous portion 80 extending upwardly from flange 41 that extends outwardly away from pole 10 and gradually tapers inwardly toward pole 10 as portion 80 extends upwardly. In FIG. 4, portion 80 terminates at an outwardly extending annular flange 82 having an annular opening therein for receiving sealing member 26 therein. However, it should be understood that cover 14 may be configured having different geometric shapes and may be configured to extend upwardly along pole 10 to different lengths. As illustrated in FIG. 4, sealing member 26 is located near an upward portion of cover 14 to reduce or eliminate water, dirt or any other unwanted debris from entering between pole 10 and cover 14.

Thus, embodiments of pole assembly 8 provide a cover 14 and sealing member 26 that are configured to abut and/or otherwise engage/contact at least a portion of pole 10 to prevent unwanted debris from entering between cover 14 and pole 10. Embodiments of pole assembly 8 also provide a cover 14 to at least partially conceal and enclose anchor 12 to enable concealment of openings 16 and the associated attachment bolts. Further, embodiments of pole assembly 8 provide a cover 14 that may be shaped substantially corresponding to the shape of anchor 12 and is geometrically complementary in shape to anchor 12 so as to fit snug over anchor 12. In some embodiments, cover 14 may extend upwardly along pole 10 and contain one or more ornate and/or geometric variations as cover 14 extends upwardly. However, it should be understood that the shape of cover 14 may be otherwise configured.

What is claimed is:

1. A pole assembly, comprising:
a pole configured to have a fixture coupled to one end thereof, the pole coupleable to an anchor to support the pole; and
a cover having a shape geometrically complementary to a shape of the anchor to at least partially conceal at least a portion of the anchor.

2. The assembly of claim 1, wherein the cover comprises a sealing member extending to the pole.

3. The assembly of claim 1, wherein the cover comprises an annular sealing member extending about a perimeter of the pole between the cover and the pole.

4. The assembly of claim 1, wherein the cover is coupleable to the anchor.

5. The assembly of claim 1, wherein the anchor is coupleable to a support surface.

6. The assembly of claim 1, wherein the anchor comprises at least one opening for securing the anchor to a support surface, and wherein the cover is configured to cover the at least one opening.

7. The assembly of claim 1, wherein the cover comprises an opening slideable over the pole, and wherein the cover is configured to prevent unwanted material from passing through the opening between the cover and the pole.

8. A pole assembly, comprising:
a pole having a first end coupled to a fixture and a second end coupled to an anchor; and
a cover disposed over the anchor and extending about a perimeter of the pole, the cover comprising a sealing member configured to abut the perimeter of the pole.

9. The assembly of claim 8, wherein the cover is coupleable to the anchor.

10. The assembly of claim 8, wherein the anchor is coupleable to a support surface.

11. The assembly of claim 8, wherein the anchor comprises at least one opening for securing the anchor to a support surface, and wherein the cover is configured to cover the at least one opening.

12. The assembly of claim 8, wherein the cover extends from the pole to a support surface supporting the anchor.

13. The assembly of claim 8, wherein the sealing member comprises an elastomeric gasket.
